(19) United States
(12) Patent Application Publication
(10) Pub. No.: US 2011/0315085 A1
(43) Pub. Date: Dec. 29, 2011

(54) Aquaculture geodesic fish cage

(76) Inventor: Peter B. Lindgren, Pompano Beach, FL (US)

(21) Appl. No.: 12/822,710

(22) Filed: Jun. 24, 2010

(51) Int. Cl. A01K 63/02; A01K 61/00; A01K 63/04

(52) U.S. Cl. 119/203; 119/223; 119/231

(57) ABSTRACT

Disclosed is a geodesic aquaculture fish cage formed from an injection molded composite structure having adjustable buoyancy. The composition structure is component based made and constructed from standardized structural tube members that are coupled together to form independently sealable chambers. Junction nodes interconnect with the structural tube members and are constructed and arranged to provide a standardized support platform through hole that can be capped with an access port, harvester port, feeder port, tower support, or with individual tie-down brackets. A tower with a self contained power supply can be attached for use in navigation identification, communication, and automation.

### FIELD OF THE INVENTION

This invention is related to the field of aquaculture fish farming, and in particular, to an improved open ocean fish cage that can be readily moved from contaminated waters for use in aquaculture fish farming.

### BACKGROUND OF THE INVENTION

On Apr. 20, 2010, a semi-submersible exploratory offshore drilling rig in the Gulf of Mexico exploded resulting in an oil spill described as the largest environmental disaster in U.S. history. Due to the location of the oil leak, nearly one mile beneath the surface of the water, accurate predictions of the volume of oil released is not possible. While the owners of the drilling rig estimate that an oil leak between 1,000 and 5,000 barrels a day is occurring, scientists have estimated oil flow rates up to 84,000 barrels per day (13,400 m3/d). A second, smaller leak has been estimated to be releasing 25,000 barrels per day (4,000 m3/d) by itself suggesting that the total size of the leak may well be in excess of 100,000 barrels per day.

No matter what the actual amount of oil has leaked, or will continue to leak, the oil spill is contaminating the coast lines of Texas, Louisiana, Mississippi, Alabama and Florida. The oil spill threatens wildlife refuges, ecologically sensitive areas, fisheries, densely populated waterfronts. Efforts to address the oil spill include controlled burns which have limited or no success. Inflatable booms have been deployed wherein floating oil is contained and skimmers are then used to draw oil from the surface. However, the oil disperses very quickly making containment difficult, even when the seas are calm.

To combat the oil spill huge quantities of chemical dispersant are being deployed in an effort to stop as much of the slick as possible from reaching land. Oil dispersants are detergent-like chemicals that break up oil slicks on the surface of the water into smaller droplets, which can then be broken down by bacteria in the water and by other natural processes. Dispersants can help prevent the oil droplets from coalescing to form other slicks. However, oil spill dispersants do not reduce the total amount of oil entering the environment. Rather, they change the chemical and physical properties of the oil, making it more likely to mix into the water column than to contaminate the surrounding waters. Dispersants alter the destination of the toxic compounds in the oil, redirecting its impact from feathered and fur-bearing animals on shore to organisms in the water column itself and on the seafloor. Most critically, a large quantity of the dispersant is being injected into the oil leak at the ocean bottom, some 5000 feet deep. The result is the suppressing of a large amount of oil from every reaching the surface of the water.

The current deployment of dispersants will likely result in the single largest deployment of dispersants against an oil spill in U.S. history. Reports indicate that nearly 140,000 gallons (529,928 liters) of dispersants have been used within the first 50 days of the oil spill.

Corexit® and other dispersants, made up of classified chemicals may result in a devastating effect in the Gulf. Aside from the fact that dispersants never before have been used on such a vast scale, the current chemicals are being injection at the well head over 5000 deep which has never occurred before. In addition, many of the dispersants are made up of classified chemical so it is not possible to access the danger they pose when the ingredients are kept confidential.

Thus, the oil spill threatens a major food supply. The clean-up of the oil is estimated to take years. The damage to certain fisheries may take a life time to repair. Certain species of fish may be extinguished.

In addition, the U.S. imports over $9.6 billion dollars worth of seafood each year with 60% aquaculture grown. This represents approximately 40,000 jobs that can be brought to the Gulf of Mexico if a system was employed that can “fish around” the damaged areas. In view of the massive loss of jobs caused by the spill, including the livelihood of conventional fisherman, what is needed is a system for offshore aquaculture fishing that can be adapted to fish in safe waters, be capable of withstanding hurricane force winds, and be readily moveable to avoid man made disasters. Offshore aquaculture in the Gulf of Mexico can directly replace some of the longest lasting impacts of the current oil spill by replacing wild fishing with farming planned in safe unaffected clean sites.

Aquaculture is the rearing of marine organisms under controlled conditions and has been practiced for thousands of years. For instance, it is known that Talapia was farmed during early Egypt times.

Aquaculture facilities may be used to house many different types of fish such as halibut, haddock, cod, flounder, bass, snapper, cobia, tuna, mahi mahi, and so forth. In the Gulf of Mexico, the species of immediate threat are the red drum, spotted trout, grouper, snook, cobia, triple tail, pompano, and mullet snappers to name a few.

Historically ocean water fish farming has been done in protected near shore areas where access to the cages has been very good and cleaning and maintaining cage screens has been affordable and not prohibitive due to open sea conditions, distance and increasing labor rates. Current offshore aquaculture containment structures are typically sheltered from harsh weather and ocean waves in bays, fjords and by islands. However, sheltered areas for aquaculture are quickly becoming saturated and bays are becoming polluted from over farming densities.

Today many countries have used and over used the acceptable protected aquaculture sites and are now forced to go offshore to expand. The United States is committed to develop an offshore aquaculture plan for federal waters. Most of the U.S acceptable sites are 10 to 70 miles offshore and in areas that are susceptible to severe weather. The solution for severe weather areas is underwater cages that are not affected by surface waves.

The Gulf of Mexico is in a hurricane zone and known European and Asia technology is not adaptable to the area. Offshore aquaculture is one of the few options available to create jobs and provide seafood security.

Offshore aquaculture is a more modern development because of the obstacles of maintaining large structures in offshore conditions. Open ocean offshore aquaculture imposes the highest demands on equipment exposed in high energy ocean environments. The purpose of the open ocean aquaculture is to raise a species of fish in a controlled environment. The open ocean environment allows for the natural cleansing of the holding pen without the concentration of waste found in near shore aquaculture. Open ocean aquaculture facilities consist of cages, holding pens, or the like that may be free floating, secured to a structure, or lowered to the ocean bottom. Open ocean aquaculture also makes use of the vast area of the ocean wherein cage size is not limited, as compared to the placement of cages within bays or the like tightly boarded area. The fish farming industry has enjoyed a steady strong growth for many years and can produce sustainable high quality fish products.

Extensive offshore floating facilities are currently found in most costal countries such as Australia, Chile, China, France, Ireland, Italy, Japan and Norway. The United States has only a few open ocean facilities while other countries are experimenting with such facilities such as Panama, Korea, Spain, Mexico, Brazil and other Central and South America countries. Labor offshore has many difficulties including poor working conditions, health risk and transportation costs. This is especially true for underwater cages where divers are required for almost all of the work.

Offshore aquaculture is among the fastest growing industries today. Fish consumption is rising and wild stocks are unable to meet demand. Many ocean species contain valuable omega oils that are recommended by doctors for good health. These 3 oils are not abundantly found in fresh water species. The health benefits of ocean fish will continue to drive demand for ocean grown fish for decades to come. Offshore aquaculture has not developed in the United States despite the fact that the United States has the largest exclusive economic zone in the world at 3.4 million square miles.

Environmental concerns and labor rates of the developed countries are the new barriers for continued growth of the industry. While many new aquaculture operations are looking to go offshore despite higher costs, the problems for offshore cages are very different and require advanced infrastructures to be reliable and competitive. The new requirements include automation, communication, monitoring and more concern for environment and personal safety. Damaged cages will result in huge financial losses, and fish escapes may effect the environment.

Most fish cage designs consist of a floating arrangement in a rectangular dock arrangement or in one or more large polyethylene pipes placed in a circle with netting underneath. Improvements have been in lower cost and better durability as the fish farms have been forced further offshore because of a lack of sheltered sites. Floating offshore cages are unsightly and are exposed to threats from high seas, hurricanes, above and below water predators including humans, and are navigation hazards.

Open ocean cages are generally a gravity style cage or a floating style cage, or hybrids thereof. Gravity cages depend on gravity to sink the net and form the shape of the cage. Floating cages usually use inexpensive common trawl netting with antifouling chemicals to retard marine growth. Large floating cages usually have a walkway around the perimeter making work from the surface easy, however some disadvantages exist. High currents can sweep up the net reducing the volume of the cage and stressing the fish wherein substantial mortalities can occur. Also, surface cages take a beating as rough weather can breach a cage and result in the total loss of the fish by escape or predator entrance.

Because floating cages cost less then other cages, currently they are the most popular. Farmers can save costs by finding reasonably sheltered areas for location sites. Often these sites are near populations having less ocean currents and are not environmentally sound. Surface cages are more vulnerable to rough sea failures and with common netting, the fish are more vulnerable for attack by birds, mammals and sharks.

Currents also cause problems for cages as the currents can change the shape of the netting and lower effective volume of the cages, as well as the high maintenance of floating hardware and current cleaning expenses due to the present day net design.

A common problem with such facilities is the exposure to the elements wherein damage to the containment facility can quickly result in a loss of contained fish. For instance, should a facility consist of a cage with netting, a breach in the cage structure can result in the release of the fish into the open water or the introduction of predators into the cage. Exposure to the elements is not limited to wave action but includes predators such as sharks that work tirelessly to find or create a breech in the netting for access to the fish.

Currently there are several types of cages that address individual issues.

Bourdon U.S. Pat. No. 4,716,854 discloses an open sea aquaculture fish cage installation that comprises a central structure similar to an offshore drilling platform and several floating modules anchored to the seabed.

Bones U.S. Pat. No. 5,628,279 discloses an hexagonally framed aquaculture fish cage that is raised and lowered along the submerged support columns of an offshore oil platform. The pens rely on injection-molded, fiberglass-reinforced grating panels painted with antifouling paint. The grating panels are supported in a rigid, generally hexagonal structure. An optional net may be installed if the fish are too small to be contained by the grating panels.

Koma U.S. Pat. No. 4,957,064 discloses an aquaculture fish cage having a polygonal frame composed of a multiplicity of frame elements. An upper net is hung down from the polygonal frame and is slackened enough so that it has a length of slack sufficient to cover up and down movement of the polygonal frame caused by waves. A lower net composed of a side net fixed to the upper net and a bottom portion fixed to a bottom end of the side net is provided. The lower net has an opening at its top end. Underwater floats are fitted to the side net, and mooring wires are provided to moor the bottom end of the lower net to the bottom of the sea.

Willinsky U.S. Pat. No. 5,251,571 discloses an offshore containment pen in the shape of a geodesic sphere formed of hubs and interconnecting struts. The hemispheric nets are attached to the interior of the sphere, by attaching the net at many points. The sphere can be lowered below the ocean surface, and it can rotate at the surface using an axle and buoyant elements incorporated into the sphere.

Zemach U.S. Pat. No. 5,412,903 discloses a metal skeleton with a superimposed netting covering the skeleton.

McRobert U.S. Pat. No. 6,216,635 discloses a aquaculture pen having a frame for suspending of a net. The frame is sufficiently buoyant to suspend a net without sinking below the water level.

Knott U.S. Pat. No. 6,386,146 discloses an aquaculture cage having a buoyant upper support for positioning at the water surface, a side wall projecting below the surface of the water formed from a contractible non buoyant panels.

Zemach U.S. Pat. No. 6,481,378 discloses an aquaculture cage having controllable buoyancy having multiple chambers that can be submerged and refloated.

Page U.S. Publication 2006/0102087A1 & 2008/0000429A1 disclose various geodesic cage designs for use with aquaculture.

Niezrecki U.S Publication 2005/0235921 discloses a self deployable open ocean aquaculture cage and underwater structure.

While previous geodesic cages exist, known cages are designed from many different triangles to form a sphere like cage. The angles between each section become closer and closer to 180 degrees as the shape gets larger. The ability to pull hard perpendicularly at any point gets lower as the sphere gets larger. As the spheres get larger they quickly become more fragile.

Disclosed is an improved offshore aquaculture fish cage that addresses the needs of future fish farmers and the immediate need of placing fish in an area that is not contaminated.

### SUMMARY OF THE INVENTION

Disclosed is a geodesic aquaculture fish cage formed from an injection molded composite structure having adjustable buoyancy formed from hollow tube members that interconnect with a series of junction nodes. The junction nodes also provide through holes that can be use as access ports, harvester ports, feeder ports, tower supports, or used as tie-down brackets. In one embodiment where the cage is placed just below the water line, a tower with a self contained power supply can be attached for use in navigation identification, communication, and automation. Navigation aides can include lighting and transponders for identification. Video and data transmission and be used for monitoring of all conditions.

Thus an objective of the invention is to disclose an offshore fish cage that is durable and able to withstand movement to areas not affected by oil or in the event of severe weather conditions.

Another objective of the invention is to disclose an offshore fish cage having a self-contained infrastructure for support of navigational lighting and identification. Such an infrastructure will allow frequent movement as an oil spill moves due to current or weather patterns.

Still another objective of the invention is to disclose an offshore fish cage having an infrastructure to support communications including data and video, and mounts for cameras, oxygen sensors, current sensors and the like instruments.

Another objective of the invention is to disclose an offshore fish cage capable of generating storing power by solar, wind generator, wave generator, or a generator powered by fuel.

Another objective of the invention is to disclose an offshore fish cage that improves safety to operators by use of multiple node entrances.

Still another objective of the invention is to disclose an offshore fish cage that can be attached at several points for towing and anchoring, including single point mooring, and has fastening points for wires, cables and conduits.

Still another objective of the invention is to disclose an offshore fish cage that is low in cost, can be upgraded, and employs standard replacement parts.

Another objective of the invention is to disclose an offshore fish cage that has precision buoyancy control, can float high and rotate, and the high flotation allows for towing and the use of heavy or dense screens.

Another objective of the invention is to disclose an offshore fish cage that has precision buoyancy control that allows for stable anchoring dynamics and optimizes flotation characteristics to meet any off shore static or dynamic condition.

Still another objective of the invention is to disclose an offshore fish cage that can accommodate and integrate automated feeding systems and harvesting systems, and has no internal obstructions to inhibit automated cleaning equipment.

Another objective of the invention is to disclose an offshore fish cage that can accommodate any type of screen and is self supporting for dry dock construction.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objectives and features thereof.

### BRIEF DESCRIPTION OF THE DRAWINGS

FIG. 1 is a pictorial view of an aquaculture cage of the instant invention;

FIG. 2 is a pictorial vies of an aquaculture cage secured to a mooring;

FIG. 3 is a perspective view of two frame members;

FIG. 4 is an exploded view of FIG. 3;

FIG. 5 is a perspective view of a junction fitting for the frame members;

FIG. 6 is a top view of FIG. 5;

FIG. 7 is a section view A-A of FIG. 6;

FIG. 8 is a detail view B of FIG. 7;

FIG. 9 is an exploded view of FIG. 5;

FIG. 10 is a pictorial view of a junction fitting with a feeder;

FIG. 11 is a pictorial view of a junction fitting with a harvester;

FIG. 12 is a pictorial view of a junction fitting with an access hatch;

FIG. 13 is a pictorial view of a communications tower secured to the aquaculture cage;

FIG. 14 is a pictorial view of the base of a communications tower secured to the aquaculture cage;

FIG. 15 is a pictorial view of a communications tower; and

FIG. 16 is a pictorial view of a smaller incubator cage attached to the aquaculture cage.

### DETAILED DESCRIPTION OF THE PREFERRED EMBODIMENT

The fish cage of the instant invention is formed from a geodesic structure that is capable of having a capacity greater than 2000 cubic meters while maintaining the strength necessary to resist most any wave action, including turbulence created by hurricane force winds.

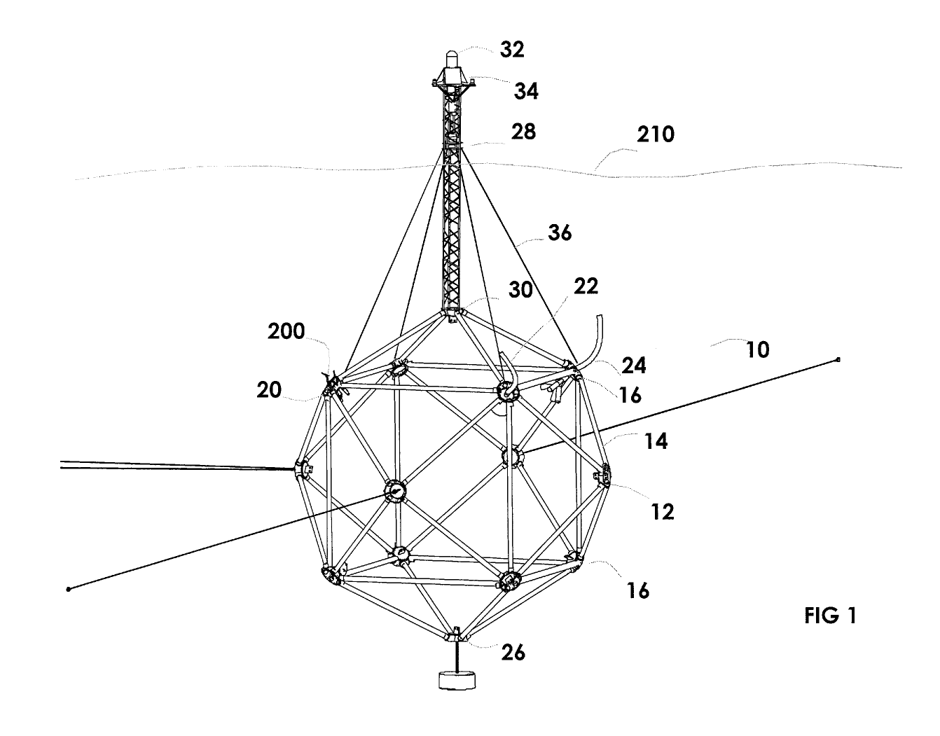

Referring now to the figures in general, and in particular to FIG. 1, disclosed is the geodesic aquaculture fish cage (10) of the preferred embodiment. The structure consists of a plurality of outer edge junction nodes (12) and insertion junction nodes (16) that are conically shaped with angled attachment flanges and used to secure cylindrical shaped hollow tube frame members (14) into a geodesic shaped structure. The outer edge junction nodes are positioned along an outer edge of the structure and each use four attachment flanges which are not connected directly to an adjoining outer edge junction node. The outer edge junction nodes are connected to the insertion junction nodes (16) which have six attachment flanges to create a plurality of triangular segments. The nodes preferably include an anti-fouling or antimicrobial agent.

A screen is placed within each of the formed triangular segments and fastened to the tube members. The preferred screen is formed from a molecularly oriented single strand filament that is crossed and welded at predetermined intersections to make the screen or net configuration. The filament is molecularly oriented by stretching to a ratio of between 2:1 and 6:1. The filament has a cross section of at least 2.0 mm in any direction and is an extruded thermoplastic material made from nylon, polyester, polyethylene, polyurethane or polypropylene having a preferred cross section in a “D” or oval shape to better facilitate welding the intersections. An antimicrobial or biocide may be added to the filament. The screen or net is preferably of a bright color such as yellow, green, white or a translucent white. The preferred material is further described in co-pending patent application Ser. No. 12/779,066, the contents of which are incorporated herein by reference.

The outer edge junction nodes (12) and the junction node (16) allow for modification of the structure in accordance with the intended use. For instance, in diver dependant cages a diver can enter the screened cage by use of a hinged access hatch (20) that is shown as secured to a junction node and is sized to allow the passage of a diver carrying tanks (200) into the cage. The insertion junction node illustrated includes a cone shaped pick-up apparatus (22) for harvesting fish. The fish are drawn by use of a vacuum pump such as that disclosed in U.S. Pat. No. 7,462,016 the contents of which are incorporated herein by reference. Additionally an apparatus (24) is provided for feeding for inserting of fish food through a junction node into the chamber of the fish cage. Tie down bracket (26) is illustrated through a number of the nodes for use in securing the structure to anchors, a mooring, or for use in towing the structure to a location. The use of the junction nodes provide a stable attachment point for such items thereby eliminating the risk of fish loss due to a screen or frame modification. The use of standardized frame and junction node members lowers the manufacturing, assembly and maintenance costs.

A tower structure (28) is shown securable to at least one of the junction nodes (30). The tower structure projects outwardly a predetermined distance allowing extension above the water level (210) to provide an indication that the cage is submerged. The tower preferably includes navigation lights (32) which are powered by batteries and recharged by solar panels (34). The tower structure (28) can include support guidelines (36) for coupling to various junction nodes thereby adding stability to the tower.

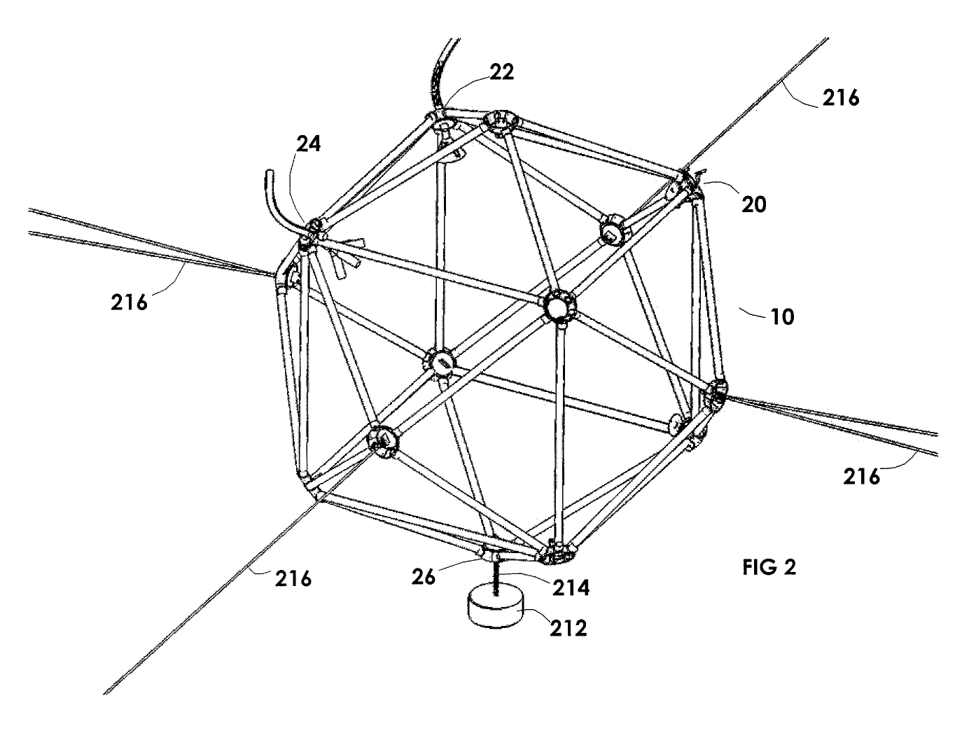

FIG. 2 is a tower-less embodiment of the geodesic aquaculture fish cage (10) illustrating a tie down bracket (26) secured to a mooring structure (212) by length of chain (214). In this embodiment anchors are placed at offset angles, as depicted by the anchor lines (216) positioned about the structure thereby providing stability in areas prone to changing currents or wave actions caused by high winds such as hurricanes. In this embodiment the structure (10) does not have a communications tower but includes the use of a harvesting apparatus (22) for drawing of the live fish as well as the feeding apparatus (24) for providing nutrients to the fish. Unique to the apparatus is the ability to place the hinged access hatches (20) through any of the junction nodes so as to provide multiple locations for ingress and egress for the safety of divers.

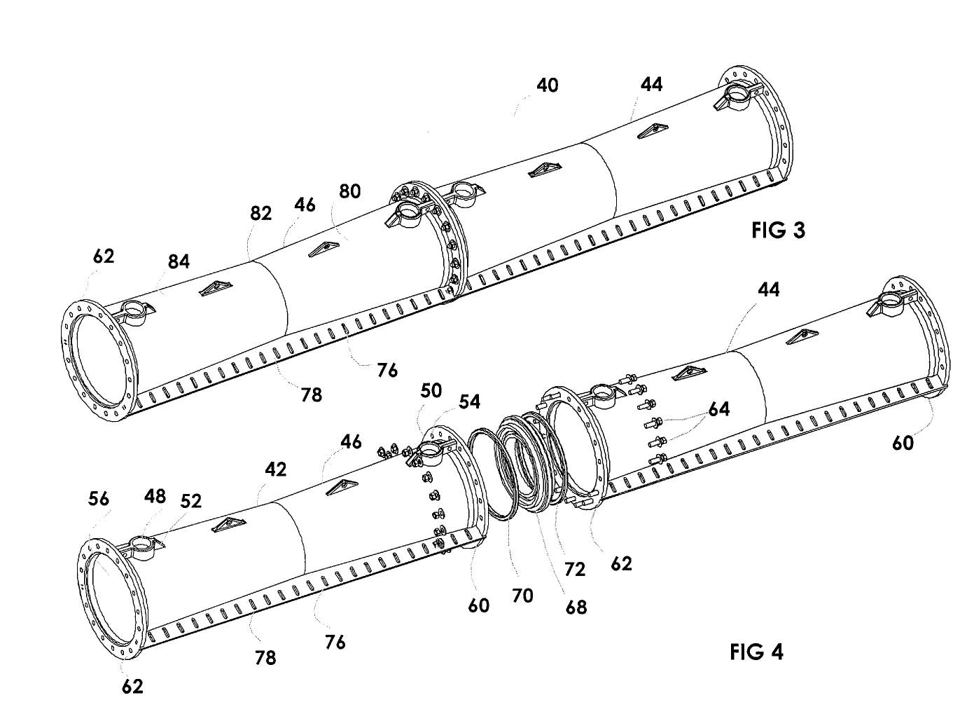

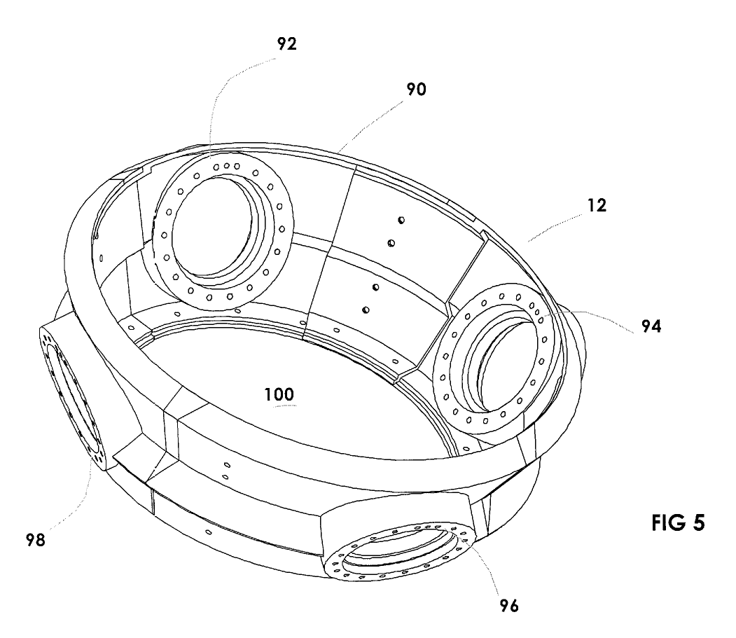

FIG. 3 depicts a cylindrical hollow tube frame member (40) formed by a plurality of molded tube segments (42 and 44). The molded tube segments include a continuous side wall (46) having an access port (48 and 50) placed into the side wall and shown with reinforced gussets (52) and (54). The access ports can be used for the introduction of air into the cavity (56) of the molded tube segment (42) to provide buoyancy to the structure. Use of a second access port (50) can be also be used for buoyancy control, for instance, the port can be used in the controlled escape of the air or in the alternative can be used for flooding of the chamber so as to place buoyancy at a predetermined level. Adjoining molded tube segments as illustrated by (42) and (44) are coupled together by the use of first flange member (60) for securement against first flange member (62). Flange members include a plurality of bolt holes for receipt of securement bolts (64) and attachment fasteners (66). A blocking seal member (68) is insertable between the flange members and for enhanced sealability the use of O-rings (70) and (72) conform to a lip within each flange and conforming to a lip in the seal (68) providing a fluid seal between the adjoining tube segments (42 and 44). Molded tube segment (42) shown with a screen attachment rail (76) having a plurality of slots (78) for attachment of a screen by use of a fastener. As noted, the rail (76) extends from the first end (60) to the second end (62). For structural strength the side walls (46) can be conical shaped along a first end (80) extending from flange (60) to a central location (82). Similarly a conical shaped wall (84) can be formed from the second flange (62) to the center point (82). Attachment rail (76) further provides structural reinforcement to the molded tube segment by extending between the flanges forming a structural rib along the side surface. The attachment rail allows securement of a flat screen to the molded tube.

In the preferred embodiment, the molded tube segments are formed from injection molded plastics. Preferably plastic is reinforcement molded plastic of nylon, PET, or the like having between 30-60 percent glass providing a tensile strength of 20,000 psi and higher and flex modules of 1,000,000 psi and higher. It should be noted that cast and fabricated parts may also be used because it is believed that the injection molded plastic having uniform parts is the most economical for the segment construction. In addition, it should be noted that the molded tube segments are standardized as they are all equal in length and may be reversed wherein the first flange can operate as the second flange and vice versa.

The basic physical value of an engineering material can be expressed by taking (cost/lb×density) divided by the tensile strength.

Materials

| Description | Strength | | Cost | Sp. Gr. | Cost adj |
|---|---|---|---|---|---|
| Steel low carbon pipe | 35 | yield | .75 | 7.8 | .16 |
| Stainless Steel ⅛ hard 304L | 75 | yield | 2.50 | 7.8 | .26 |
| Aluminum | 40 | yield | 2.20 | 2.7 | .148 |
| Plastics composites | | | | | |
| Dow questra | 19.1 | Yield | 2.00 | 1.32 | .138 |
| EMS grivory PVS 5H | 24.7 | | 3.50 | 1.58 | .224 |
| GV - 5H | 30.5 | ultimate | 3.00 | 1.56 | .153 |
| GV_6H | 37.5 | ultimate | 4.00 | 1.69 | .180 |
| Plastic lumber | 5 | ultimate | 2.00 | .95 | .38 |
| Fiber thermostes 50% | | | | | |
| Glass epoxy | 47 | | 6.00 | 2.0 | .24 |
| Basalt epoxy | 100 | | 8.00 | 2.0 | .16 |
| Kevlar epoxy | 110 | | 16.00 | 1.8 | .23 |
| Carbon epoxy | 200 | | 45.00 | 1.9 | .43 |

While plastic is the preferred construction material, the nodes and frame members can be made from any rigid material. Plastics can be coated with an anti-growth material similar to steel frames. Plastic composites having imbedded antimicrobials provide the best weight for strength advantage. For instance, testing of underwater salt water growth in various plastics revealed that a basalt composite part grew only tube worms. The use of basalt in the test demonstrated physical properties that made it cost effective and that basalt did not absorb water like glass fiber. Resins with imbedded antimicrobials are also possible with composites. The actual material chosen is dependant upon the location and expected marine growth.

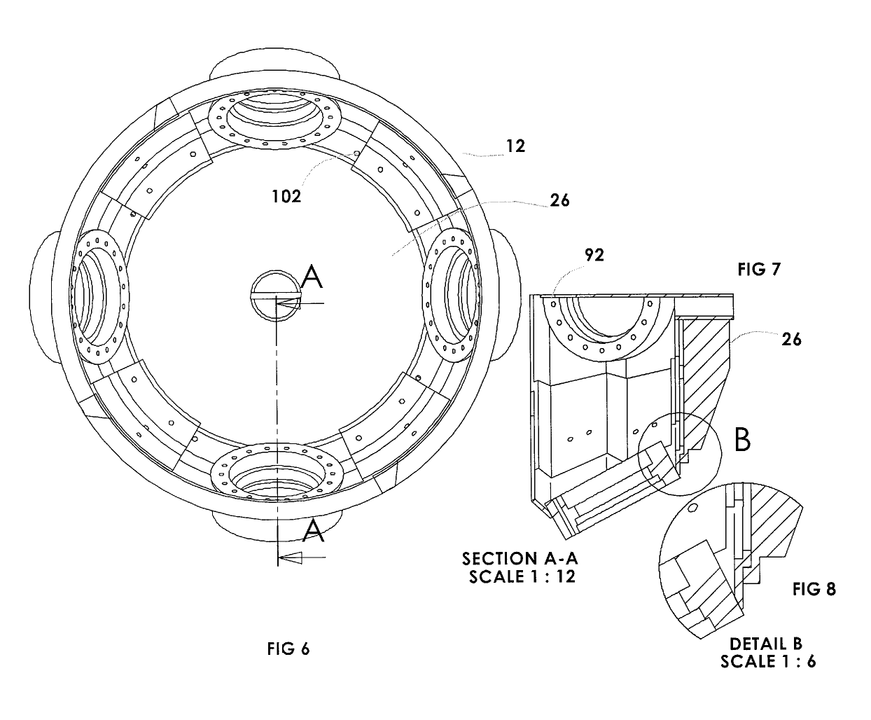

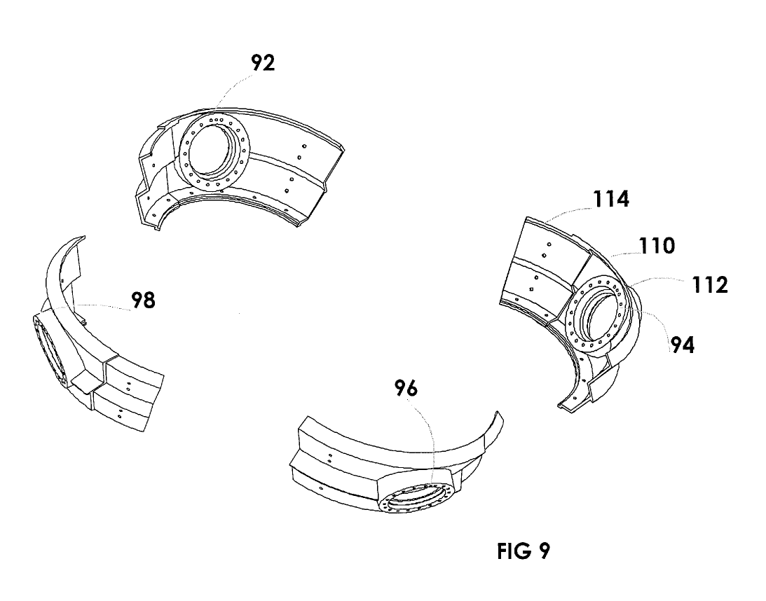

Now referring to FIGS. 5-9, disclosed is an outer edge junction node (12) depicted by a conical shaped housing (90) having spaced apart attachment flanges (92, 94, 96 and 98). A centrally located through hole (100) is available for attachment of the aforementioned access hatch, harvesting fish apparatus, feeding fish apparatus, tie down bracket, or the tower structure. The junction node can be cast as a single piece, or as shown in the illustration, the use of multiple pieces allows the node to be constructed to a four or six flange junction. It should be noted that three, five or even seven flange junction could also be used in the geodesic structure and deemed to be within the scope of this invention. FIG. 6 illustrates the junction node (12) from a top view with tie down bracket (26) secured thereto. The tie down bracket is bolted to the node through fastener holes (102) located along the perimeter of the junction node. It should be noted that the adjustability of the junction node is made possible by use of larger segments (110) or by the slidable expansion allowed wherein each segment has a flange section (112) and an attachment section (114) which is shown as an undercut to allow securement to an adjoining segment. FIGS. 7 and 8 depict a section of the cap capture which allows the tie down bracket to be easily aligned with the fastener holes of the junction node.

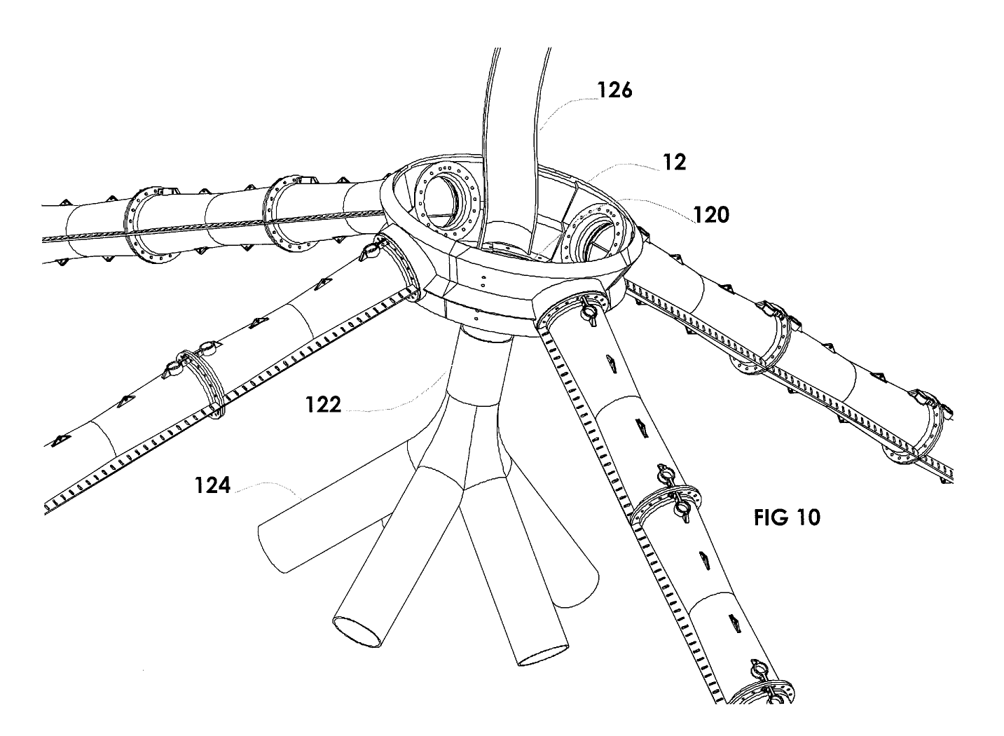

Referring now to FIG. 10 set forth is an outer edge junction node (12) illustrating a means for harvesting fish consisting of an apparatus having a base plate (120) securely to the passage way of the node (12). A discharge pipe (122) includes a plurality of a discharge orifices (124) wherein food and nutrients delivered through a delivery tube (126) and distributed within the cage by orifices (124) providing even distribution therein.

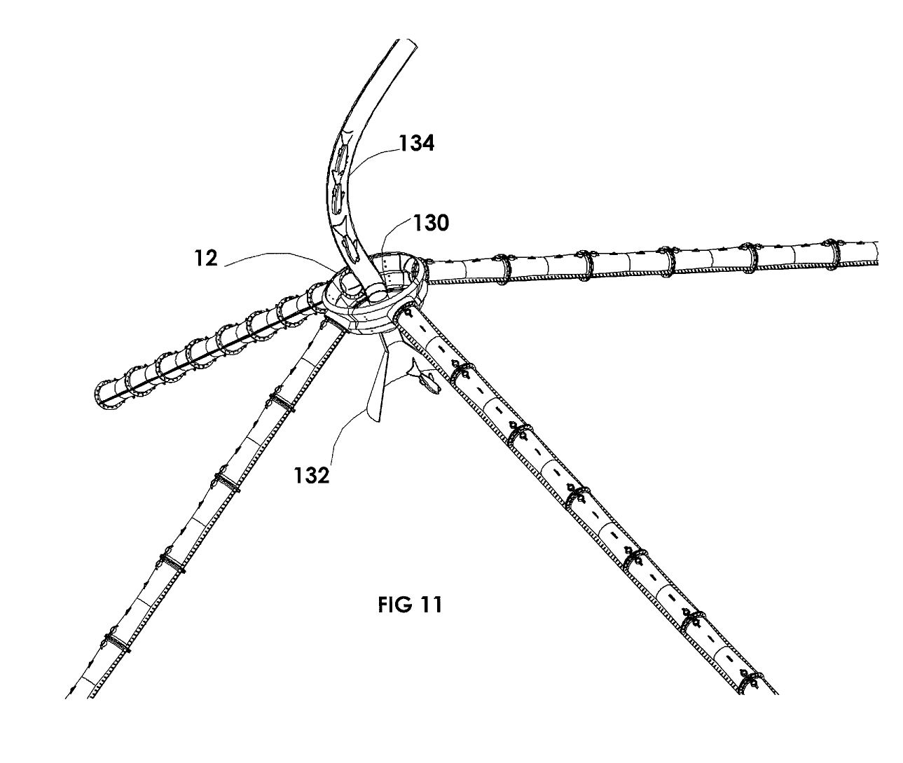

FIG. 11 depicts an outer edge junction node (12) having a means for harvesting fish consisting of a mounting plate (130) secured to the through hole of a node with a conical shaped inlet (132) attached to a suction hose (134). The harvesting tube is coupled to a specialty design fish pump such as disclosed in U.S. Pat. No. 7,462,016. The harvesting apparatus allows for the gentle movement of the fish from one location to another or during the subsequent harvest of the fish farm. Fish are drawn through the harvesting apparatus with little or no stress so as to maintain longevity of the fish.

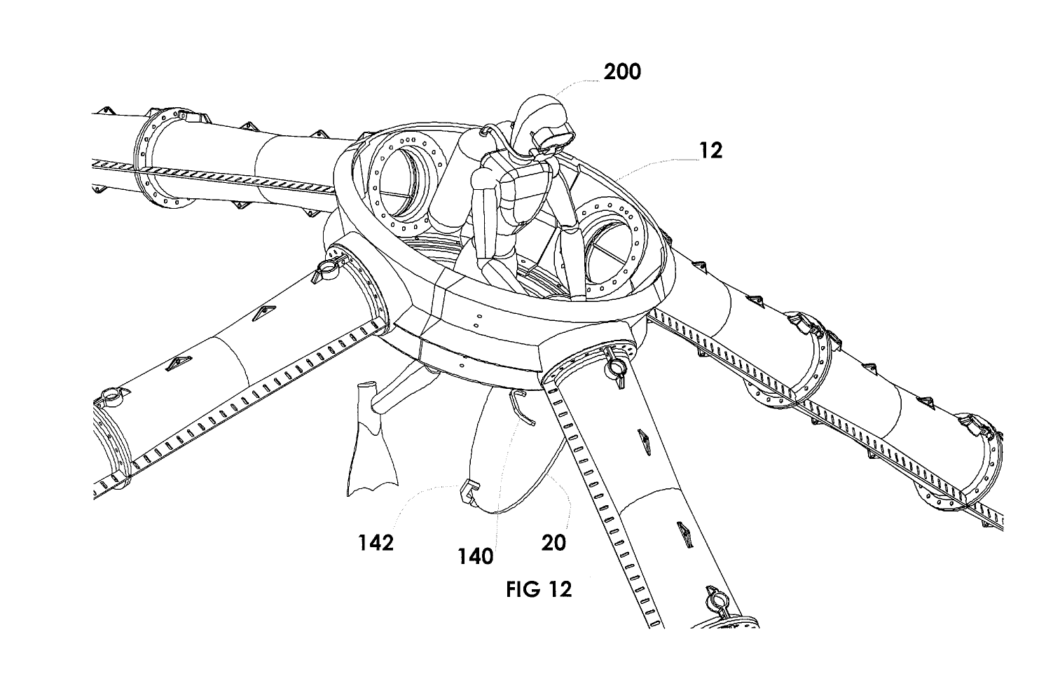

FIG. 12 depicts an outer edge junction node (12) having an access hatch (20) which is secured to the through hole of the node and hinged having a handle (140) to provide ease of control by the diver (200) during ingress and egress. A latch mechanism (142) maintains the hatch in a closed and locked position when not in use. The ability to place access hatches throughout the structure aids in the safety to the divers who service the structure. Ideally the access hatches are placed in every node that does not need a tie down or feeding/harvesting apparatus.

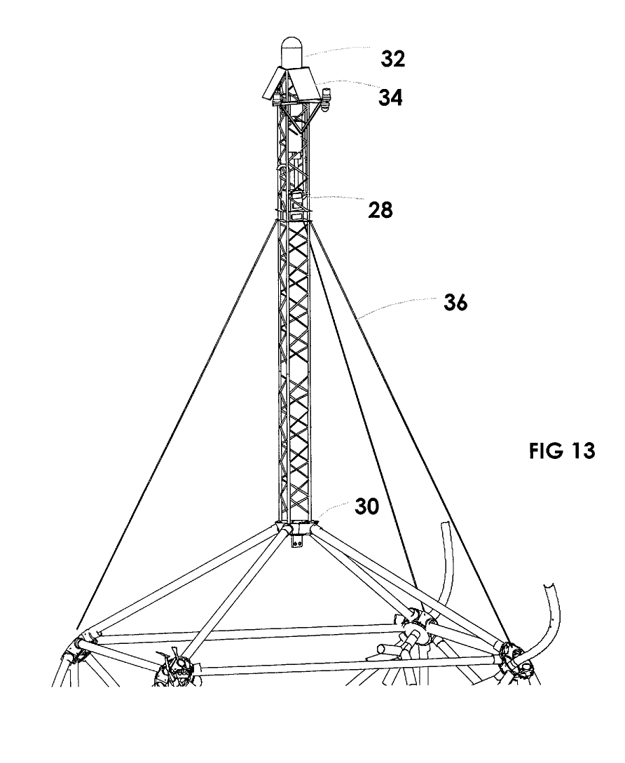

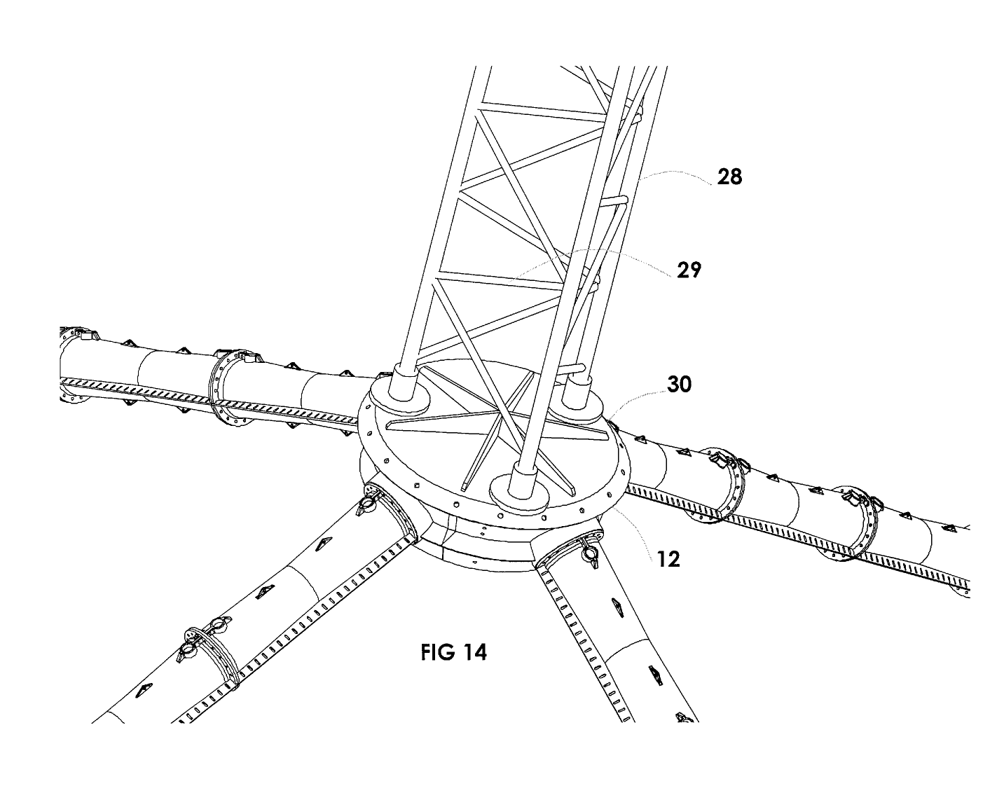

Now referring to FIGS. 13 and 14, set forth is the tower structure (28) shown attached to an outer edge junction node (30) with securement tie downs (36) further coupled to adjoining junction nodes. The tower structure is designed to project out of the water a distance to provide a navigation aid for those vessels around the structure during day and night. The tower employs navigation lights (32) for use at night and solar panels (34) provide recharging of the batteries during the day as well as providing a reflective surface. The structure having sufficient material and reflectivity from the panels to allow convenient ship radar to pick up the structure thereby addressing navigational hazards during the day. The tower structure has triangular placement of cross connects (29) to provide enhanced stability. The heavy duty standardized nodes make attachment of most any device, including sensors and accessories, a simple task.

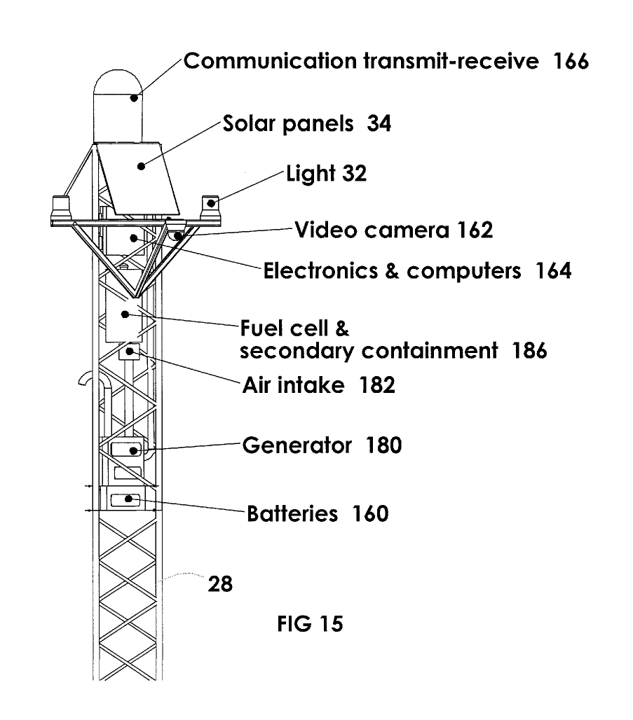

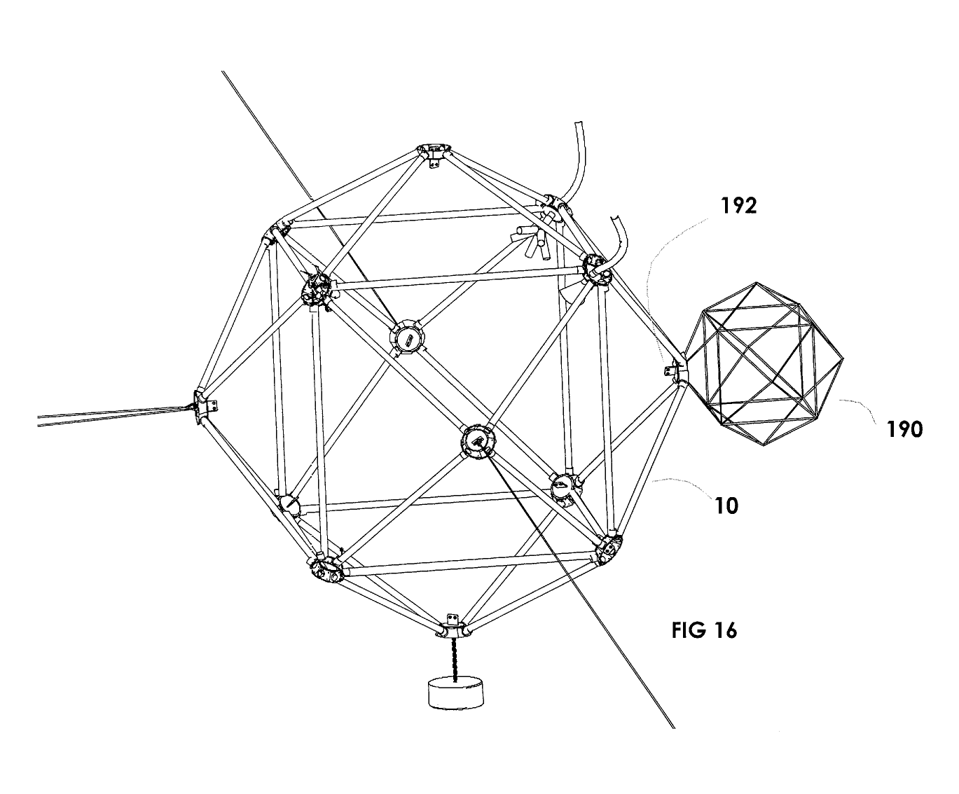

FIG. 15 illustrates a communications tower structure (28) having the navigation lights (32) with solar panels (34) providing power through a battery (160). The communications tower may include the use of a camera (162) including electronics (164) that allow for spooling of the data for transfer through a transmitter receiver (166) for purposes of communicating by satellite, RF transmitter, or in storage drive for later review. A fuel power generator (180) may also be used to provide power to the batteries as well as for use in providing power as necessary for servicing the fish cage. The generator having an air intake (182) with an exhaust (184) and a fuel cell (186). This generator may also be used to provide portable power to divers for use with air compressors, to avoid the need of carrying tanks, or any other type of power accessory needed to maintain the fish cage.

FIG. 16 depicts the use of an aquaculture cage (10) adjoined by a smaller, but similarly formed, incubator cage (150). The illustration exemplifies an embodiment that allows juvenile fish to be grown in a controlled area and, upon reaching a mature stage, released into the larger cage (12) by opening of the through hole (192). Additional cages can be further attached, not shown, which can provide a staging area for growing fish in independent age/size groups.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should by understood that the invention as claimed should not be unduly limited to such specific embodiments. Indeed, various modifications of the described modes for carrying out the invention which are obvious to those skilled in the art are intended to be within the scope of the following claims.

What is claimed is:

1. An aquaculture fish cage comprising:
a plurality of junction nodes, at least one said junction node having a centrally located through-hole;
a plurality of sealable hollow tube frame members having a sealable first end securable to one of said junction nodes and a sealable second end securable to an adjoining of said junction nodes to define a frame;
a screen attachment rail positioned between said first end and said second end of said hollow tube frame member; and
a plurality of screen segments securable between each said hollow frame member to define a water permeable enclosure for fish; and
wherein each said hollow tube frame member can be filled with air or water to provide precision buoyancy.

2. The aquaculture fish cage according to claim 1 wherein said hollow tube frame members have sufficient sealable volume to float over 50% of said fish structure above the surface of the water.

3. The aquaculture fish cage according to claim 2 wherein said tube frame members are formed from connectable segments, having sealable ends, said connectable segments secured together to form a hollow multi-segment frame member.

4. The aquaculture fish cage according to claim 3 wherein two assembled connectable segments are required in a ratio of 4:5.

5. The aquaculture fish cage according to claim 3 wherein said connectable segments include a draft from a central bore area increasing bore diameter towards said first end and said second end.

6. The aquaculture fish cage according to claim 1 wherein said enclosable structure is formed from 36 hollow tube frame members interconnected with 12 junction nodes to form a geodesic shape.

7. The aquaculture fish cage according to claim 1 wherein each said junction node is constructed from a plurality of flanged sections to form a perimeter suitable to attach between 4 and 6 hollow tube frame members at predetermined angles.

8. The aquaculture fish cage according to claim 1 wherein said hollow tube frame members and said junction nodes are constructed from injection molded plastic.

9. The aquaculture fish cage according to claim 1 wherein said hollow tube frame members and interconnecting junction nodes are constructed from polymers reinforced with fibers of glass, basalt, or carbon

10. The aquaculture fish cage according to claim 9 wherein said fiber reinforced is over 20% by weight.

11. The aquaculture fish cage according to claim 1 wherein said hollow tube frame members and the interconnected junction nodes include an anti-fouling or antimicrobial agent.

12. The aquaculture fish cage according to claim 1 including an accessory securable to each said through-hole, said accessory selected from the group of: hatch means, fish harvester means, fish feeder means, tie-down bracket means; or a tower mount means.

13. The aquaculture fish cage according to claim 1 including a tower structure having a proximal end securable to at least one said junction node and distal end securable to multiple junction node by use of guide wires, said tower including a navigation light, a battery for powering said navigation light, and a means for restoring power to said battery.

14. The aquaculture fish cage according to claim 13 wherein said tower includes a communication system having at least one video camera and a means for communicating video images to a remote location.

15. The aquaculture fish cage according to claim 1 wherein said molded tube segments are further defined by a flanged first end and a flanged second end with a continuous side wall therebetween, said side wall including at least one port for the insert of fluid or air into said tube, and a means for sealing one said molded tube segment with an adjoining molded tube segment.

16. A geodesic aquaculture fish cage comprising:
a plurality of outer edge junction nodes, at least one of said outer edge junction nodes including a centrally located through-hole;
a plurality of insertion junction nodes, at least one said intersection junction node including a centrally located through hole;
a plurality of sealable hollow tube frame members having a first end securable to one of said junction nodes and a second sealable end securable to an adjoining junction node to form a geodesic shaped frame, said hollow tube frame member including a buoyancy means;
a screen attachment rail positioned between said first end and said second end of said hollow tube frame member; and
a plurality of screen segments securable between each said hollow frame member to define a water permeable enclosure for fish; and
a least one said junction node including a frame attachment means;
wherein each said hollow tube frame member can be filled with air or water to provide buoyancy to said frame member for ease of towing and cleaning whereby said frame members having sufficient sealable volume to float over 50% of the structure above the surface of the water to provide precision buoyancy.

17. The geodesic aquaculture fish cage according to claim 16 wherein each said outer edge junction node is constructed from four identically shaped sections fastened together.

18. The aquaculture fish cage according to claim 16 wherein said tube frame members are formed from connectable segments, each connectable segment having a first end and a second end, said first end of a tube frame member fastened to a second end of an adjoining frame member.

19. The aquaculture fish cage according to claim 18 wherein two assembled connectable segments are required in a ratio of 4:5.

20. The aquaculture fish cage according to claim 18 wherein said connectable segments include a draft from a central bore area increasing bore diameter towards said first end and said second end.

21. The aquaculture fish cage according to claim 16 wherein each said insertion junction node is constructed from three identically shaped spacer flanges alternating with three identically shaped segment flanges to form a perimeter suitable to attach between six hollow tube frame members at predetermined angles.

22. The aquaculture fish cage according to claim 16 wherein said hollow tube frame members and said junction nodes are constructed from injection molded plastic.

23. The aquaculture fish cage according to claim 16 wherein said hollow tube frame members and said junction nodes are constructed from polymers reinforced with fibers of glass, basalt, or carbon.

24. The aquaculture fish cage according to claim 23 wherein said fiber reinforced is over 20% by weight.

25. The aquaculture fish cage according to claim 16 wherein said hollow tube frame members and said junction nodes include an anti-fouling or antimicrobial agent.

26. The aquaculture fish cage according to claim 16 including an accessory secured to said through-hole, said accessory selected from the group of: hatch means, fish harvester means, fish feeder means, tie-down bracket means; or a tower mount means.

27. The aquaculture fish cage according to claim 16 including a tower structure having a proximal end securable to at least one said junction node and distal end securable to multiple junction node by use of guide wires, said tower including a navigation light, a battery for powering said navigation light, and a means for restoring power to said battery.

28. The aquaculture fish cage according to claim 27 wherein said tower includes a communication system having at least one video camera and a means for communicating video images to a remote location.
